(19) United States
(12) Patent Application Publication
(10) Pub. No.: US 2020/0265736 A1
(43) Pub. Date: Aug. 20, 2020

(54) AUTOMATIC-BRAKE SIMULATOR FOR FOUR-WHEEL VEHICLE

(71) Applicant: IROC CO., Ltd., Nagoya-shi, Aichi (JP)

(72) Inventor: Takuma KOGA, Nagoya-shi (JP)

(73) Assignee: IROC CO., Ltd., Nagoya-shi, Aichi (JP)

(21) Appl. No.: 16/652,200

(22) PCT Filed: Mar. 23, 2018
(86) PCT No.: PCT/JP2018/011847

§ 371 Date: Mar. 30, 2020

(30) Foreign Application Priority Data
Nov. 10, 2017 (JP) 2017-217114

(51) Int. Cl. G09B 9/042

(52) U.S. Cl. CPC G09B 9/042

(57) ABSTRACT

An automatic-brake simulator (A) for a four-wheel vehicle is constituted by a body portion (a seat (11), a curved frame (12), a frame (13), a base (14), universal joints (15), and electric actuators (16)), an operation portion (a driving-operation device (2)), a control portion (a control-use computer (3), a sensor group (4), an orientation sensor (5), and a storage (6)), and an audiovisual portion (a head-mounted display (7), speakers (8), and a display (9)). When an automatic brake is activated, the seat on which an experiencing person (T) sits vibrates, and shifts and inclines forward, backward, leftward, rightward, upward, and downward in response to actuation of a group of the electric actuators while a composite VR moving image on the head-mounted display becomes still in a state in which a virtual obstacle is present immediately before the eyes.

### CROSS REFERENCE TO RELATED APPLICATIONS

The present application is based on Japanese Patent Application No. 2017-217114, filed on Nov. 10, 2017, the contents of which are incorporated herein by reference.

### TECHNICAL FIELD

The present disclosure relates to an automatic-brake simulator for a four-wheel vehicle.

### BACKGROUND ART

Automatic braking systems, such as those in PTL 1 (automatic braking system) and PTL 2 (vehicle-use emergency automatic braking system), that automatically apply braking in response to a vehicle approaching an obstacle have been made practicable. PTL 3 discloses a vehicle driving simulator.

### CITATION LIST

### Patent Literature

PTL 1: Japanese Unexamined Patent Application Publication No. 2009-214764

PTL 2: Japanese Unexamined Patent Application Publication No. 10-315938

PTL 3: Japanese Unexamined Utility Model Registration Application Publication No. 3-43676

### SUMMARY OF INVENTION

These automatic braking systems are mounted on actual vehicles. Thus, experience sessions in which an experiencing person rides on a demonstration vehicle on which an automatic braking system is mounted and travels on an experience course toward an expanded polystyrene simulating an obstacle have been provided. In such a case, preparing a large space and an obstacle, in addition to a demonstration vehicle, requires costs and takes time.

Meanwhile, the vehicle driving simulator in PTL 3 has less reality.

An object of the present disclosure is to provide an automatic-brake simulator for a four-wheel vehicle that enables an experiencing person to experience behavior of an automatic braking system safely and with enhanced reality without preparing an experience course and an obstacle.

### [Regarding Claim 1]

An automatic-brake simulator for a four-wheel vehicle is constituted by a body portion (a seat, a curved frame, a frame, a base, universal joints, and electric actuators) of a simulator, an operation portion (a driving-operation device) of the simulator, a control portion (a microcomputer, a group of sensors, an orientation sensor, and a storage) of the simulator, and an audiovisual portion (a head-mounted display and speakers) of the simulator.

The seat for an experiencing person to sit thereon includes a seat portion and a back portion.

The curved frame fixes the seat with the seat placed on the upper surface of the curved frame.

The frame having a substantially U-shaped sectional shape includes a front extended portion, a rectangular plate-shaped portion, and a back extended portion and is positioned on the lower side of the curved frame.

The rectangular base is positioned on the lower side of the frame and is placed on a floor.

The universal joints are disposed between a front-side center portion of the upper surface of the base and a front-side portion of the lower surface of the plate-shaped portion of the frame and between a center portion of the upper surface of the frame and a front-side portion of the lower surface of the curved frame.

The cylindrical electric actuators are disposed between a back-side left portion of the upper surface of the base and a left upper portion of the back extended portion of the frame, between a back-side right portion of the upper surface of the base and a right upper portion of the back extended portion of the frame, between a back-side left portion of the upper surface of the plate-shaped portion of the frame and a back-side left upper portion of the curved frame, and between a back-side right portion of the upper surface of the plate-shaped portion of the frame and a back-side right upper portion of the curved frame.

The driving-operation device includes, at least, a steering wheel, a shift lever, a clutch pedal, an accelerator pedal, and a brake pedal. These driving-operation devices are disposed on the front extended portion of the frame and operable by the experiencing person.

The group of the sensors each detects an operation amount by which the experiencing person operates the driving-operation device including the steering wheel, the shift lever, the clutch pedal, the accelerator pedal, and the brake pedal.

The orientation sensor detects a direction of the heat-mounted display.

The head-mounted display, which is to be mounted on the head of the experiencing person, displays a composite VR moving image (composite 360-degree 3D-VR moving image), which is described later. Specifically, a virtual driver seat including a group of virtual meters and a virtual steering wheel is displayed together with a scene outside the vehicle and successively varies in linkage with operation of the driving-operation device.

The storage stores a VR-moving-image file, which is a 360-degree 3D-VR moving image, and a CG file created by computer graphics.

The VR-moving-image file includes a moving image previously photographed by traveling on an actual course with a photographing vehicle on which a camera capable of photographing a 360-degree three-dimensional virtual reality moving image is disposed and a virtual obstacle created by computer graphics and incorporated into the photographed VR moving image (360-degree 3D-VR moving image).

The CG file includes an image (digital data) of a virtual four-wheel vehicle including a virtual driver seat that includes, at least, the group of the virtual meters and a virtual steering wheel.

The microcomputer includes a calculating means, a CG-image varying means, a VR-moving-image varying means, a combining means, a viewpoint changing means, an effect-sound generating means, and an actuator controlling means.

The calculating means of the microcomputer calculates, based on each operation amount of the driving-operation device detected by the group of the sensors, behavior of the virtual four-wheel vehicle, the behavior including a traveling speed, an engine speed, and a steering direction.

The CG-image varying means of the microcomputer varies, based on each behavior calculated by the calculating means, a CG image of the virtual four-wheel vehicle including the virtual driver seat.

The VR-moving-image varying means of the microcomputer increases and decreases, based on a traveling speed of the virtual four-wheel vehicle calculated by the calculating means, a reproduction speed of a VR moving image (360-degree 3D-VR moving image) and changes, based on a steering direction of the virtual four-wheel vehicle, a displaying direction of the VR moving image (360-degree 3D-VR moving image).

The combining means of the microcomputer creates a composite VR moving image (composite 360-degree 3D-VR moving image) by combining the CG image of the virtual four-wheel vehicle including the virtual driver seat with the VR moving image (360-degree 3D-VR moving image), the CG image and the VR moving image varying successively.

The viewpoint changing means of the microcomputer changes, based on a direction of the head-mounted display detected by the orientation sensor, a viewpoint direction in which the experiencing person views the composite VR moving image (composite 360-degree 3D-VR moving image).

The effect-sound generating means of the microcomputer generates, based on behavior of the virtual four-wheel vehicle including a traveling speed and an engine speed, the effect sound and outputs the effect sound to a speaker.

Consequently, the speaker disposed on the frame emits the effect sound, including an engine noise of the virtual four-wheel vehicle, based on the behavior of the virtual four-wheel vehicle.

The actuator controlling means of the microcomputer controls, based on behavior of the virtual four-wheel vehicle calculated by the calculating means, a group of electric actuators. In response to the actuation of the group of the electric actuators, the seat on which the experiencing person sits vibrates, and shifts and inclines forward, backward, leftward, rightward, upward, and downward.

When a reproduction elapsed time of the composite VR moving image has reached a previously-set elapsed time for standard reproduction, the microcomputer stops the virtual four-wheel vehicle before the virtual obstacle by actuating an automatic brake that maximizes a brake working amount.

When the automatic brake of the virtual four-wheel vehicle is actuated, the seat on which the experiencing person sits vibrates, shifts, and inclines, similarly to when an automatic brake of an actual four-wheel vehicle is actuated, in response to the actuation of the group of the electric actuators. The speaker emits an effect sound in which a squeal noise of tires and an engine noise are varied similarly to when an automatic brake of an actual four-wheel vehicle is actuated.

In response to the virtual four-wheel vehicle stopping when the automatic brake of the virtual four-wheel vehicle is actuated, the composite VR moving image on the head-mounted display becomes still in a state in which the virtual obstacle is present immediately before the eyes.

Until the automatic brake of the virtual four-wheel vehicle is actuated, the experiencing person can obtain reality similar to actual traveling by driving a four-wheel vehicle, from the composite VR moving image (composite 360-degree 3D-VR moving image) displayed on the head-mounted display, behavior of the seat in linkage with the composite VR moving image, and an effect sound emitted by the speaker.

The automatic-brake simulator for the four-wheel vehicle enables an experiencing person to experience behavior of an automatic braking system safely and with enhanced reality without preparing an experience course and an obstacle.

### [Regarding Claim 2]

In the automatic-brake simulator for the four-wheel vehicle, braking by an antilock brake that prevents virtual tires of the virtual four-wheel vehicle from being locked and braking that does not prevent the virtual tires from being locked are selectable in operation of the brake pedal by the experiencing person and in actuation of the automatic brake.

Therefore, the experiencing person can feel behavior that is during actuation of the brake that includes the automatic brake in different states with and without the antilock brake.

### [Regarding Claim 3]

In the automatic-brake simulator for the four-wheel vehicle, the composite VR moving image (composite 360-degree 3D-VR moving image) is transformed into a normal composite moving image by a moving-image transforming means and displayed on a display disposed at the front of the base. The composite VR moving image includes a CG image of the virtual four-wheel vehicle including the virtual seat and a VR moving image (360-degree 3D-VR moving image) that are combined with each other.

The normal composite moving image is a moving image in which a moving image of traveling on an actual course previously photographed by a photographing vehicle is combined with a CG image of the virtual four-wheel vehicle including the virtual driver seat.

Therefore, experience observers including a next experiencing person can view the composite moving image, which provides an excellent publicity effect and motivates the observers to have simulated experience.

### BRIEF DESCRIPTION OF DRAWINGS

The aforementioned object, other objects, features, and advantages of the present disclosure will be further clarified in the following detailed description with reference to the attached drawings. The drawings are:

FIG. 1 is a perspective view of an automatic-brake simulator for a four-wheel vehicle viewed from the back;

FIG. 2 is a side view of the automatic-brake simulator for the four-wheel vehicle viewed from the right direction;

FIG. 3 is a top view of the automatic-brake simulator for the four-wheel vehicle viewed from the top direction;

FIG. 4 is a back view of the automatic-brake simulator for the four-wheel vehicle viewed from the back direction;

FIG. 5 is a schematic view of a frame structure of the automatic-brake simulator for the four-wheel vehicle;

FIG. 6 is a block diagram of the automatic-brake simulator for the four-wheel vehicle;

FIG. 7 illustrates snaps of a composite moving image projected on a display of the automatic-brake simulator for the four-wheel vehicle immediately after a virtual four-wheel vehicle is started in (a), in a midway in (b), and immediately before an automatic brake is applied in (c);

FIG. 8 illustrates states immediately before the virtual four-wheel vehicle is stopped before an obstacle in response to the automatic brake being applied in the automatic-brake simulator for the four-wheel vehicle with the viewpoint present at the back of the virtual four-wheel vehicle in (a) and with the viewpoint present at a side of the virtual four-wheel vehicle in (b); and

FIG. 9 illustrates a snap of the composite moving image projected on the display of the automatic-brake simulator for the four-wheel vehicle, the snap being in a state in which the virtual four-wheel vehicle is stopped before the obstacle in response to the automatic brake being applied.

### DESCRIPTION OF EMBODIMENTS

According to an automatic-brake simulator for a four-wheel vehicle, the simulator includes a body portion (a seat, a curved frame, a frame, a base, universal joints, and electric actuators), an operation portion (a driving-operation device), a control portion (a microcomputer, a group of sensors, an orientation sensor, and a storage), and an audiovisual portion (a head-mounted display and speakers).

In the automatic-brake simulator for the four-wheel vehicle, a calculating means of the microcomputer calculates behavior, including a traveling speed, an engine speed, and a steering direction, of a virtual four-wheel vehicle on the basis of each operation amount of the driving-operation device detected by the group of the sensor; a VR-moving-image varying means of the microcomputer increases and decreases the reproduction speed of a VR moving image on the basis of the traveling speed of the virtual four-wheel vehicle calculated by the calculating means; the VR-moving-image varying means of the microcomputer changes the displaying direction of the VR moving image on the basis of the steering direction calculated by the calculating means; and a CG-image varying means of the microcomputer varies a CG image of a driver seat of the virtual four-wheel vehicle on the basis of each behavior calculated by the calculating means.

Then, a combining means of the microcomputer creates a composite VR moving image by combining the CG image of the virtual driver seat of the virtual four-wheel vehicle with the VR moving image, the CG image and the VR moving image varying successively, and a viewpoint changing means of the microcomputer changes, on the basis of the direction of the head-mounted display detected by the orientation sensor, a viewpoint direction in which an experiencing person views the composite VR moving image.

Moreover, on the basis of the behavior, including the traveling speed and the engine speed, of the virtual four-wheel vehicle, an effect-sound generating means of the microcomputer generates an effect sound and outputs the effect sound to the speakers.

On the basis of the behavior of the virtual four-wheel vehicle calculated by the calculating means, an actuator controlling means of the microcomputer controls a group of electric actuators. In response to the actuation of the group of the electric actuators, a seat on which the experiencing person sits vibrates, and shifts and inclines forward, backward, leftward, rightward, upward, and downward.

When a reproduction elapsed time of the composite VR moving image has reached a previously-set elapsed time for standard reproduction, the microcomputer stops the virtual four-wheel vehicle before a virtual obstacle by actuating an automatic brake that maximizes a brake working amount.

When the automatic brake of the virtual four-wheel vehicle is actuated, the seat on which the experiencing person sits vibrates, and shifts and inclines forward, backward, leftward, rightward, upward, and downward similarly to when an automatic brake of an actual four-wheel vehicle is actuated, in response to the actuation of the group of the electric actuators. Moreover, the speakers emit an effect sound in which a squeal noise of tires and an engine noise are varied similarly to when an automatic brake of an actual four-wheel vehicle is actuated.

In response to the virtual four-wheel vehicle stopping when the automatic brake of the virtual four-wheel vehicle is actuated, the composite VR moving image on the head-mounted display becomes still in a state in which the virtual obstacle is present immediately before the eyes of an experiencing person.

The automatic-brake simulator for the four-wheel vehicle enables the experiencing person to experience the behavior of an automatic braking system safely and with enhanced reality without preparing an actual experience course and an actual obstacle.

### First Embodiment

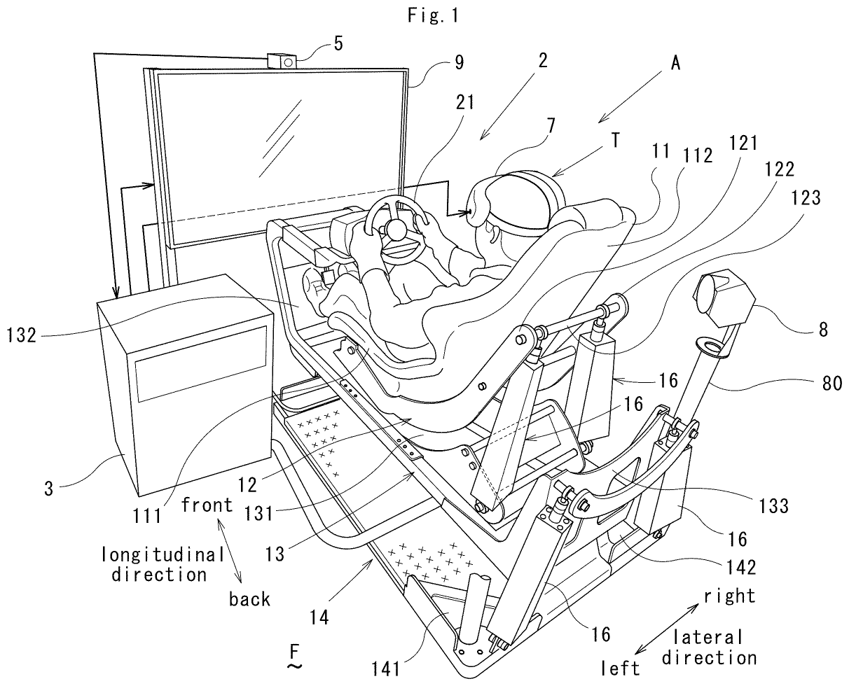

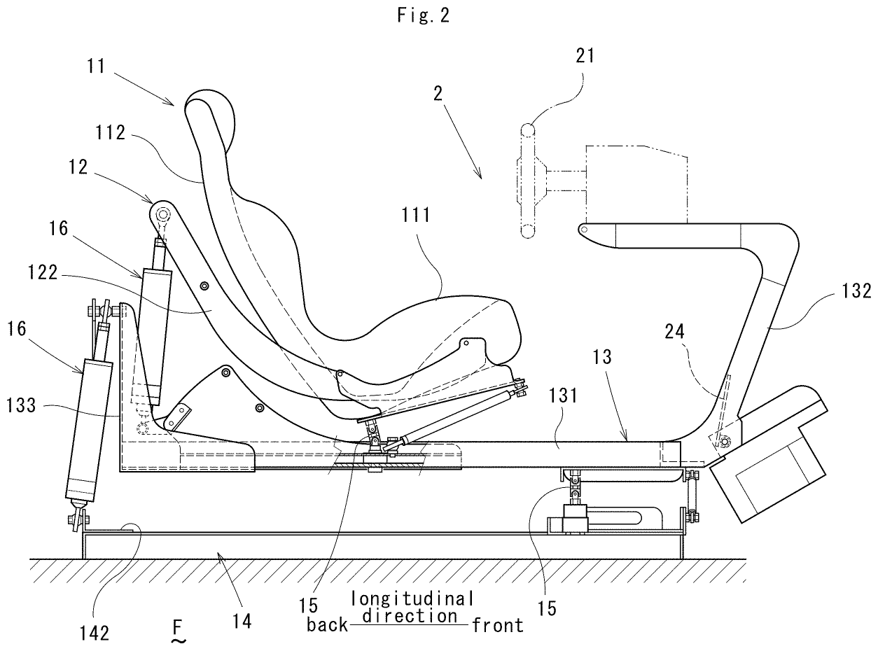

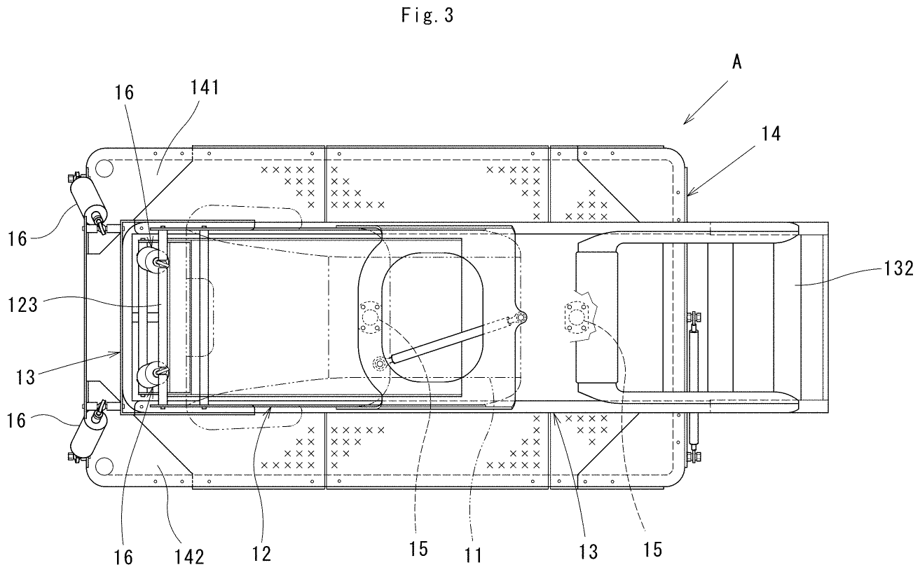

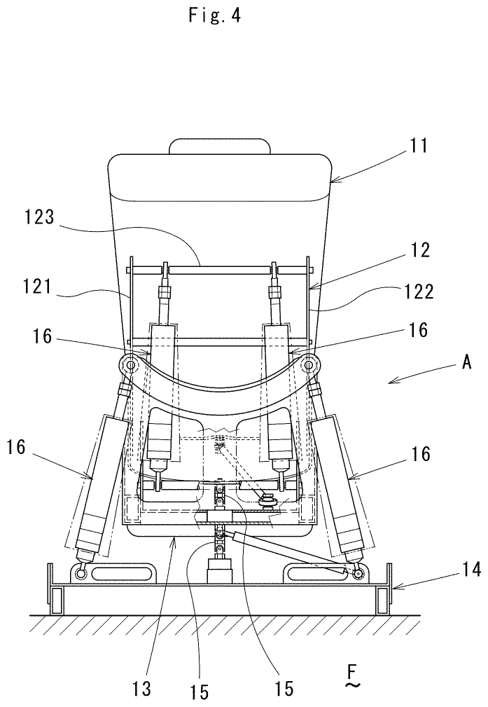

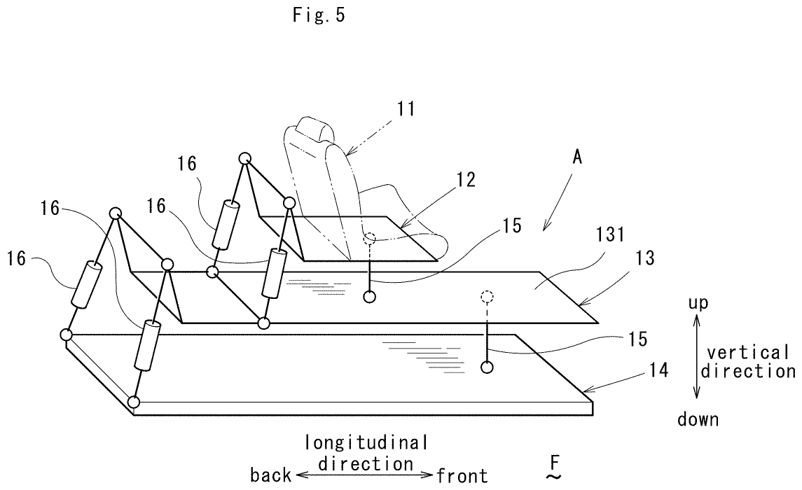

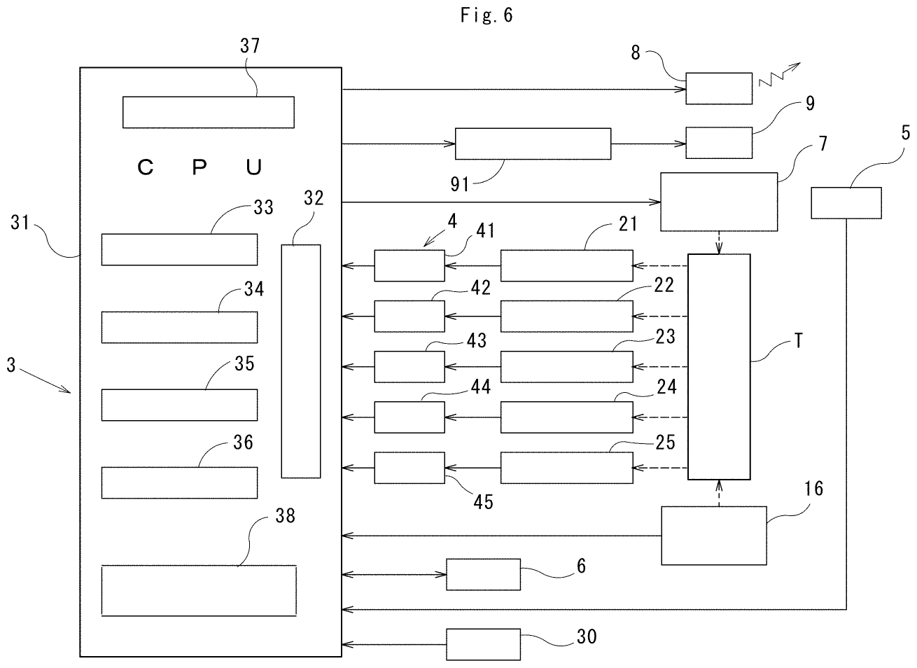

An automatic-brake simulator A for a four-wheel vehicle according to a first embodiment of the present disclosure (corresponding to claims 1, 2, and 3) will be described on the basis of FIG. 1 to FIG. 8.

The automatic-brake simulator A for the four-wheel vehicle illustrated in FIG. 1 is constituted by a body portion (a seat 11, a curved frame 12, a frame 13, a base 14, universal joints 15, and electric actuators 16), an operation portion (a driving-operation device 2), a control portion (a control-use computer 3, a sensor group 4, an orientation sensor 5, and a storage 6), and an audiovisual portion (a head-mounted display 7, speakers 8, and a display 9).

The seat 11 for an experiencing person T to sit thereon includes a seat portion 111 that supports the buttocks and the legs of the experiencing person T and a back portion 112 that supports the back of the experiencing person T.

The curved frame 12 includes curved side members 121 and 122 on the left and right sides, a horizontal coupling bar 123 that couples back ends of the side members 121 and 122 to each other, and an intermediate coupling bar (not illustrated) that couples intermediate portions of the side members 121 and 122 to each other. The curved frame 12 fixes the seat 11 placed on the upper surface of the curved frame 12.

The frame 13 having a substantially U-shaped sectional shape includes a rectangular plate-shaped portion 131, a front extended portion 132, and a back extended portion 133 and is positioned on the lower side of the curved frame 12.

The rectangular base 14 is positioned on the lower side of the frame 13 and is placed on a floor F. Corner members 141 and 142 (triangular) to each of which an extended piece is attached are welded to the back part of the base 14.

The universal joints 15 are disposed between a front-side center portion of the upper surface of the base 14 and a front-side portion of the lower surface of the plate-shaped portion of the frame 13 and between a center portion of the upper surface of the frame 13 and a front-side portion of the lower surface of the curved frame 12.

The cylindrical electric actuators 16 are disposed between the extended piece (back-side left portion of the upper surface) of the corner member 141 on the left side of the base 14 and a left upper portion of the back extended portion 133 of the frame 13, between the extended piece (back-side right portion of the upper surface) of the corner member 142 on the right side of the base 14 and a right upper portion of the back extended portion 133 of the frame 13, between a back-side left portion of the upper surface of the plate-shaped portion 131 of the frame 13 and an upper portion (back-side left upper portion) of the side member 121 of the curved frame 12, and between a back-side right portion of the upper surface of the plate-shaped portion 131 of the frame 13 and an upper portion (back-side right upper portion) of the side member 122 of the curved frame 12.

The driving-operation device 2 includes a steering wheel 21, a shift lever 22, a clutch pedal 23, an accelerator pedal 24, and a brake pedal 25 that are disposed in the vicinity of the front extended portion 132 of the frame 13 and operable by the experiencing person T.

The sensor group 4 (sensors 41, 42, 43, 44, and 45) for detecting an operation amount by which the experiencing person T operates the driving-operation device 2 is attached to each of the steering wheel 21, the shift lever 22, the clutch pedal 23, the accelerator pedal 24, and the brake pedal 25, which are the driving-operation device 2.

Outputs of the sensors 41, 42, 43, 44, and 45 are input into a microcomputer 31 of the control-use computer 3 via an interface (not illustrated).

These devices, which are the driving-operation device 2 (the steering wheel 21, the shift lever 22, the clutch pedal 23, the accelerator pedal 24, and the brake pedal 25), are preferably configured to provide, by using a reaction-force motor, a spring, a hydraulic pressure, or the like, an appropriate response to the hands of the experiencing person T when being operated by the experiencing person T.

A setting switch 30 is a switch for setting a desirable vehicle type (one type from a plurality of types of four-wheel vehicles having different specifications) and desirable travel conditions (example: ABS ON/OFF).

The speakers 8 and 8 for outputting an effect sound, including an engine noise of the virtual four-wheel vehicle, are disposed on upper portions of circular columns 80 that stand upright on the corner members 141 and 142 of the base 14.

The control-use computer 3 includes the microcomputer (CPU) 31, a storage (HDD) 6, a memory, and the like and is disposed on the floor F.

The orientation sensor 5 for detecting an orientation (direction) of the head-mounted display 7 is disposed on an upper portion of the display 9.

An OS, various drivers, a simulator control software, and the like are installed in the storage 6. The storage 6 stores a VR-moving-image file and a CG file.

The VR-moving-image file is data of a VR moving image (360-degree 3D-VR moving image) including a moving image previously photographed by traveling on an actual course in a predetermined travel pattern with a photographing vehicle on which a video camera capable of photographing a 360-degree three-dimensional virtual reality moving image is disposed, and a virtual obstacle (having a box shape) created by computer graphics and incorporated into the moving image.

The CG file includes, in addition to images of the appearance of the vehicle with turned-on brake lamps and the interior of the vehicle, an image of the virtual four-wheel vehicle that includes a virtual driver seat including a group of virtual meters, a virtual steering wheel, virtual hands holding the virtual steering wheel, the images being created by computer graphics.

Displayed contents of the virtual meters, the virtual steering wheel, the virtual hands holding the virtual steering wheel, the virtual brake lamps, and the like can be varied by the microcomputer 31.

The head-mounted display 7 is mounted on the head of the experiencing person T by using a belt, and the composite VR moving image (composite 360-degree 3D-VR moving image) is projected on the head-mounted display 7. The composite VR moving image includes the VR moving image (360-degree 3D-VR moving image) in which the virtual obstacle is incorporated into the actual course and the CG image of the virtual four-wheel vehicle combined with the VR moving image. The composite VR moving image is optimized for the left eye and for the right eye.

At the front of the base 14, the display 9 viewable by experience observers including a next experiencing person is disposed. The display 9 displays a video in which the composite VR moving image (composite 360-degree 3D-VR moving image) is transformed into a normal composite moving image by a moving-image transforming means 91.

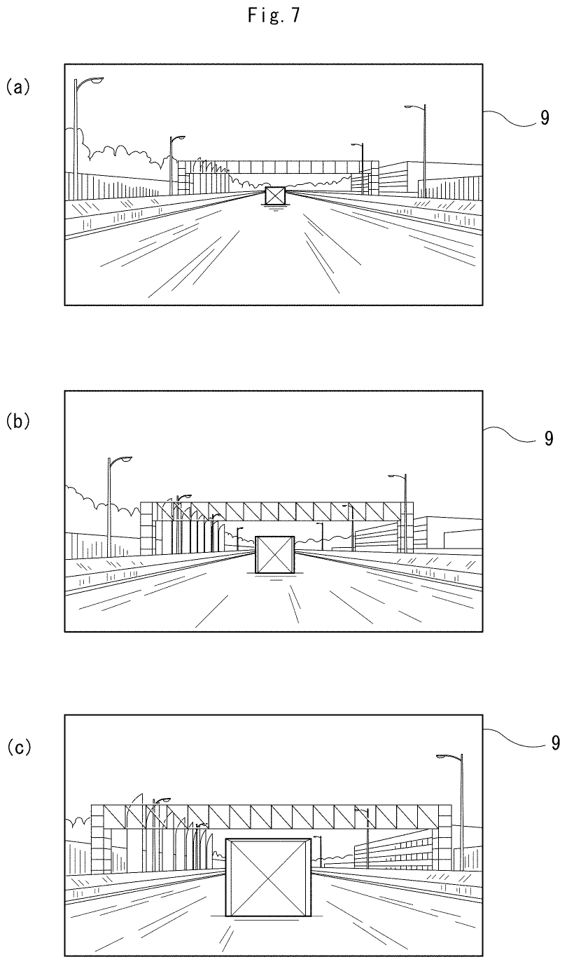

Note that (a) of FIG. 7 illustrates a composite moving image immediately after the virtual four-wheel vehicle is started, (b) of FIG. 7 illustrates a composite moving image in a midway, and (c) of FIG. 7 illustrates a composite moving image immediately before the automatic brake is applied.

The microcomputer 31 operates in accordance with the simulator control software stored in the storage 6. The microcomputer 31 and the simulator control software bear a calculating means 32, a CG-image varying means 33, a VR-moving-image varying means 34, a combining means 35, a viewpoint changing means 36, an effect-sound generating means 37, and an actuator controlling means 38.

The calculating means 32 of the microcomputer 31 calculates the behavior (the traveling speed, the engine speed, the steering direction, and the like) of the virtual four-wheel vehicle on the basis of a vehicle type and various travel conditions set by the setting switch 30 and each operation amount of the driving-operation device 2 (the steering wheel 21, the shift lever 22, the clutch pedal 23, the accelerator pedal 24, and the brake pedal 25) detected by a group of sensors 4 (sensors 41, 42, 43, 44, and 45).

The CG-image varying means 33 of the microcomputer 31 varies the CG image of the virtual four-wheel vehicle including the virtual driver seat on the basis of the behavior of the virtual four-wheel vehicle calculated by the calculating means 32.

The VR-moving-image varying means 34 of the microcomputer 31 increases and decreases the reproduction speed of the VR moving image (360-degree 3D-VR moving image) on the basis of the traveling speed of the virtual four-wheel vehicle calculated by the calculating means 32 and changes the displaying direction of the VR moving image on the basis of the steering direction of the virtual four-wheel vehicle.

The combining means 35 of the microcomputer 31 creates a composite VR moving image (composite 360-degree 3D-VR moving image) by combining the CG image of the virtual four-wheel vehicle and the VR moving image, which vary successively, with each other.

The viewpoint changing means 36 of the microcomputer 31 changes the viewpoint direction, in which the composite VR moving image is viewed by the experiencing person T, on the basis of the direction of the head-mounted display 7 detected by the orientation sensor 5.

The effect-sound generating means 37 of the microcomputer 31 generates an effect sound on the basis of the behavior of the virtual four-wheel vehicle including the traveling speed and the engine speed and outputs the effect sound to the speakers 8.

The actuator controlling means 38 of the microcomputer 31 controls a group of the electric actuators 16 to vibrate the seat 11 and shift and incline the seat 11 forward, backward, leftward, rightward, upward, and downward on the basis of the behavior of the virtual four-wheel vehicle calculated by the calculating means 32.

The combining means 35 of the microcomputer 31 creates a composite VR moving image (composite 360-degree 3D-VR moving image) by combining the CG image of the virtual four-wheel vehicle including the virtual driver seat and the VR moving image (360-degree 3D-VR moving image), which vary successively, with each other.

When a reproduction elapsed time of the composite VR moving image (composite 360-degree 3D-VR moving image) has reached a previously-set elapsed time for a standard reproduction, the microcomputer 31 stops the virtual four-wheel vehicle before the virtual obstacle by actuating the automatic brake that maximizes a brake working amount.

In the present embodiment, when the composite VR moving image (composite 360-degree 3D-VR moving image) is reproduced at the standard reproduction (=image recording speed in photographing), it takes three minutes, and the elapsed time for the standard reproduction after which the automatic brake that maximizes the brake operation amount is actuated is set to 2 minutes 40 seconds.

Specifically, when the virtual four-wheel vehicle travels in the same travel pattern as that of the photographing vehicle, the automatic brake is actuated after 2 minutes 40 seconds. When the virtual four-wheel vehicle travels in a travel pattern twice the travel pattern of the photographing vehicle, the automatic brake is actuated after 1 minute 20 seconds.

When the automatic brake of the virtual four-wheel vehicle is actuated, the seat 11 on which the experiencing person T sits vibrates, and shifts and inclines forward, backward, leftward, rightward, upward, and downward, similarly to when an automatic brake of an actual four-wheel vehicle is actuated, in response to the actuation of the group of the electric actuators 16. Moreover, the speakers 8 emit an effect sound in which the squeal noise of the tires and the engine noise are varied similarly to when the automatic brake of the actual four-wheel vehicle is actuated.

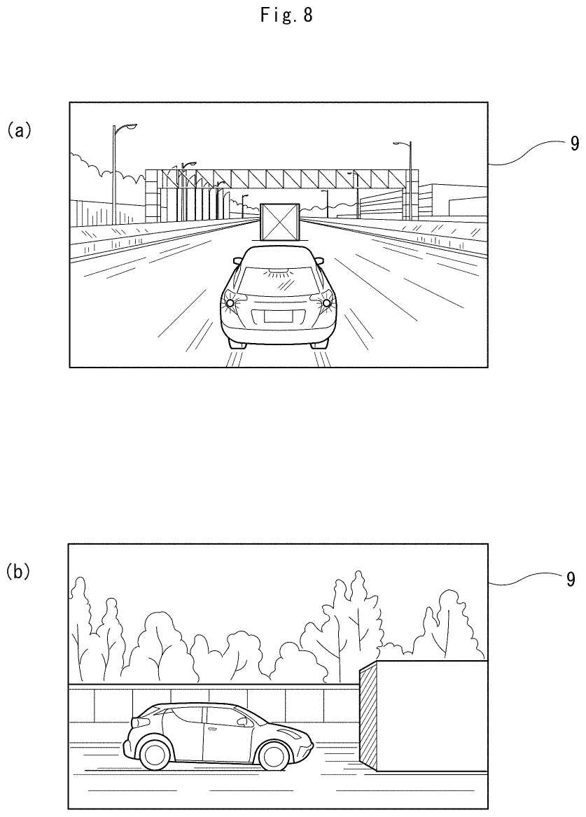

In (a) of FIG. 8, a composite moving image projected on the display 9 immediately before the virtual four-wheel vehicle is stopped before the obstacle in response to the automatic brake being applied is illustrated with the viewpoint present at the back of the virtual four-wheel vehicle. In (b) of FIG. 8, a composite moving image projected on the display 9 is illustrated with the viewpoint present on a side of the virtual four-wheel vehicle.

When the virtual four-wheel vehicle is stopped in response to the automatic brake of the virtual four-wheel vehicle being actuated, the composite VR moving image being projected on the head-mounted display 7 becomes still in a state in which the virtual obstacle is present immediately before the eyes.

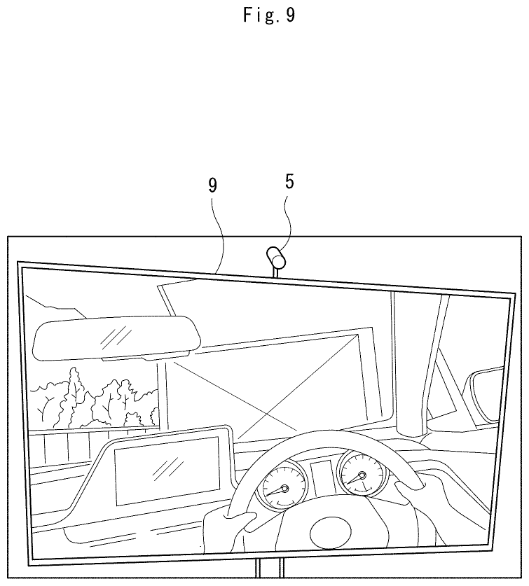

FIG. 9 illustrates a composite moving image projected on the display 9 in a state in which the virtual four-wheel vehicle is stopped before the obstacle in response to the automatic brake being applied.

Until the automatic brake of the virtual four-wheel vehicle is actuated, the experiencing person T can obtain reality similar to when actually traveling by driving a four-wheel vehicle, from the composite VR moving image (composite 360-degree 3D-VR moving image) projected on the head-mounted display 7, the behavior of the seat in linkage with the composite VR moving image, and an effect sound emitted by the speakers 8.

The automatic-brake simulator A for the four-wheel vehicle enables an experiencing person to experience the behavior of an automatic braking system safely with enhanced reality without preparing an actual experience course and an actual obstacle.

Although the present disclosure has been described in accordance with the embodiment, the present disclosure should be understood not to be limited by the embodiment and such a structure. The present disclosure involves various modifications and changed-forms equivalent to the scope thereof. In addition, various combinations and forms, and other combinations and forms that include only one element of, that includes elements in addition to, or that includes elements less than those of such combinations and forms should be also included in the category and the scope of the spirit of the present disclosure.

1. An automatic-brake simulator for a four-wheel vehicle comprising:
a seat including a seat portion and a back portion, the seat being for an experiencing person to sit thereon;
a curved frame that fixes the seat placed on an upper surface of the curved frame;
a frame that includes a front extended portion, a rectangular plate-shaped portion, and a back extended portion, the frame having a substantially U-shaped sectional shape and being positioned on a lower side of the curved frame;
a rectangular base positioned on a lower side of the frame and placed on a floor;
universal joints disposed between a front-side center portion of an upper surface of the base and a front-side portion of a lower surface of the plate-shaped portion of the frame and between a center portion of the upper surface of the frame and a front-side portion of a lower surface of the curved frame;
cylindrical electric actuators disposed between a back-side left portion of the upper surface of the base and a left upper portion of the back extended portion of the frame, between a back-side right portion of the upper surface of the base and a right upper portion of the back extended portion of the frame, between a back-side left portion of an upper surface of the plate-shaped portion of the frame and a back-side left upper portion of the curved frame, and between a back-side right portion of the upper surface of the plate-shaped portion of the frame and a back-side right upper portion of the curved frame;
a driving-operation device including, at least, a steering wheel, a shift lever, a clutch pedal, an accelerator pedal, and a brake pedal, the driving-operation device being disposed on the front extended portion of the frame and operable by the experiencing person;
a group of sensors that each detect an operation amount by which the experiencing person operates the driving-operation device including the steering wheel, the shift lever, the clutch pedal, the accelerator pedal, and the brake pedal;
a speaker disposed on the frame to emit an effect sound including an engine noise of a virtual four-wheel vehicle;
a storage that stores a VR-moving-image file and a CG file, the VR-moving-image file including a moving image previously photographed by traveling on an actual course with a photographing vehicle on which a camera capable of photographing a 360-degree three-dimensional virtual reality moving image is disposed and a virtual obstacle created by computer graphics and incorporated into the moving image, the CG file including an image of the virtual four-wheel vehicle including a virtual driver seat that includes, at least, a group of virtual meters and a virtual steering wheel, the image being created by computer graphics;
a head-mounted display that is to be mounted on a head of the experiencing person and that displays a composite VR moving image, which is described later;
an orientation sensor that detects a direction of the heat-mounted display; and
a microcomputer including a calculating means that calculates, based on each operation amount of the driving-operation device detected by the group of the sensors, behavior of the virtual four-wheel vehicle, the behavior including a traveling speed, an engine speed, and a steering direction, a CG-image varying means that varies, based on each behavior calculated by the calculating means, a CG image of the virtual four-wheel vehicle including the virtual driver seat, a VR-moving-image varying means that increases and decreases, based on a traveling speed of the virtual four-wheel vehicle calculated by the calculating means, a reproduction speed of a VR moving image and varies, based on a steering direction of the virtual four-wheel vehicle, a displaying direction of the VR moving image, a combining means that creates a composite VR moving image by combining the CG image and the VR moving image with each other, the CG image and the VR moving image varying successively, a viewpoint changing means that changes, based on a direction of the head-mounted display detected by the orientation sensor, a viewpoint direction in which the experiencing person views the composite VR moving image, an effect-sound generating means that generates, based on behavior of the virtual four-wheel vehicle including a traveling speed and an engine speed, the effect sound and outputs the effect sound to the speaker, and an actuator controlling means that controls, based on behavior of the virtual four-wheel vehicle calculated by the calculating means, a group of the electric actuators,
wherein, when a reproduction elapsed time of the composite VR moving image has reached a previously-set elapsed time for standard reproduction, the microcomputer stops the virtual four-wheel vehicle before the virtual obstacle by actuating an automatic brake that maximizes a brake working amount.

2. The automatic-brake simulator for the four-wheel vehicle according to claim 1, wherein braking by an antilock brake that prevents virtual tires of the virtual four-wheel vehicle from being locked and braking that does not prevent the virtual tires from being locked are selectable in operation of the brake pedal by the experiencing person and in actuation of the automatic brake.

3. The automatic-brake simulator for the four-wheel vehicle according to claim 1, wherein a display viewable by experience observers including a next experiencing person is disposed at a front of the base, and
wherein the display displays a composite moving image including the composite VR moving image transformed into a normal composite moving image by a moving-image transforming means.

4. The automatic-brake simulator for the four-wheel vehicle according to claim 2, wherein a display viewable by experience observers including a next experiencing person is disposed at a front of the base, and
wherein the display displays a composite moving image including the composite VR moving image transformed into a normal composite moving image by a moving-image transforming means.
